(19) United States
(12) Patent Application Publication
(10) Pub. No.: US 2005/0236106 A1
(43) Pub. Date: Oct. 27, 2005

(54) Fabric coated foam article and method for producing same

(75) Inventor: Abraham Sanfiorenzo, Bayonne, NJ (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: Maidenform, Inc.

(21) Appl. No.: 11/106,508

(22) Filed: Apr. 15, 2005

Related U.S. Application Data
(60) Provisional application No. 60/562,885, filed on Apr. 15, 2004.

(51) Int. Cl. C09J 5/00

(52) U.S. Cl. 156/324; 428/308.4

(57) ABSTRACT

The article has a first fabric layer laminated to a first surface of a foam structure and a second fabric layer laminated to a second surface of a foam structure. The exposed cells of the foam are filled with resin prior to the laminating process so that the fabric layers adhere to the foam. The finished laminated foam sheet remains flexible, does not yellow, and does not delaminate.

### CROSS REFERENCE TO RELATED APPLICATIONS

The present invention claims the benefit of U.S. Provisional Patent Application Ser. No. 60/562,885, filed Apr. 15, 2004, entitled “Fabric Coated Foam Article And Method For Producing Same,” the contents of which are hereby incorporated by reference as if set forth fully herein.

### FIELD OF THE INVENTION

The present invention is directed towards an improved laminated foam sheet and molded foam articles made therefrom. Such molded foam articles are particularly useful for, but not limited to, the manufacture of molded foam bra inserts.

### BACKGROUND OF THE INVENTION

Foam is used to create molded articles. Many of these articles use foam having a fabric covering. However, using foam having a fabric covering suffers from several drawbacks. The drawbacks include the exposed surface of the foam and fabric combination yellowing over time, the surface of the laminated foam sheet puckering or achieving an orange-peel effect over time or after washing, and the fabric delaminating from the foam.

### SUMMARY OF THE INVENTION

The present invention yields an article of manufacture that is resistant to the orange-peel or puckering effect, does not significantly yellow over time, and is resistant to delaminating.

The present article of manufacture is assembled using a fabric whose shrinkage matches that of the foam. Matching the fabric and foam shrinkage prevents the orange-peel or pucker effect.

During production, resin attaches the fabric to the foam. The resin fills and essentially eliminates air pockets on the surface of the foam. Not having air pockets prevents puckering by substantially eliminating pockets where the fabric can pucker. The layer of resin also acts to seal the surface of the foam, thereby preventing the foam from outgassing through the fabric. Preventing outgassing eliminates one source of yellowing.

The present article of manufacture is also resistant to delamination. The resin application provides an even surface for the fabric to bond to. By filling the foam pockets, as discussed above, there is less movement that can result in delamination.

### BRIEF DESCRIPTION OF THE DRAWINGS

FIG. 1 is a cross section of a foam article according to the present invention.

FIG. 2 is a depiction of a two-sided laminating process for the claimed foam article.

FIG. 3 shows a detailed view of the application of resin according to the present invention.

### DETAILED DESCRIPTION OF THE INVENTION

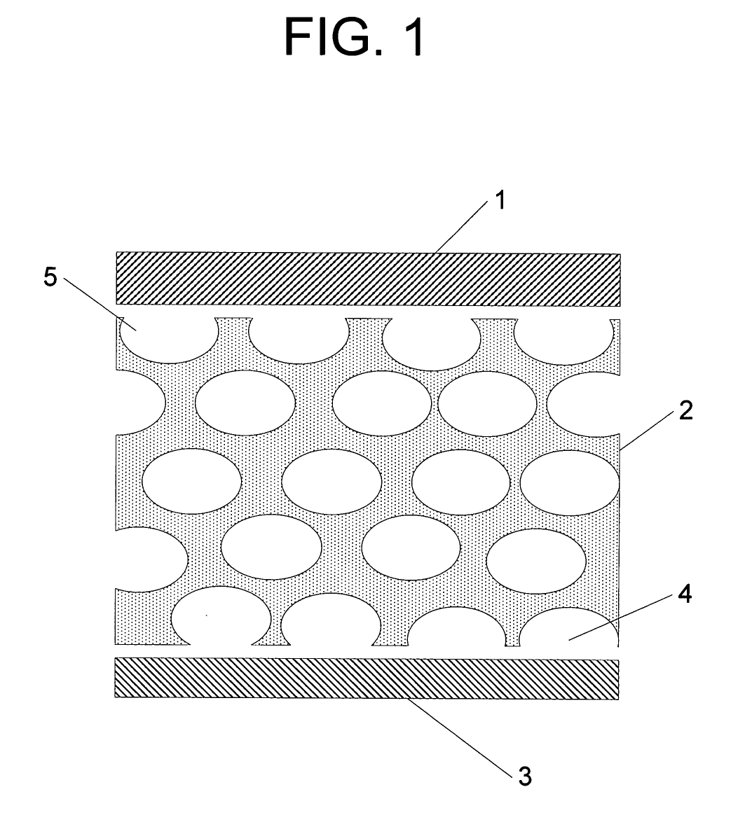

The basic structure of the article is shown in FIG. 1, which is a cross section of the laminated foam sheet. The article comprises a first fabric layer 1 laminated to a first surface of a foam structure 2 and a second fabric layer 3 laminated to a second surface of a foam structure 2. The exposed cells of the foam such as 4 and 5 are filled with resin prior to the laminating process so that the fabric layers 1 and 3 adhere to the foam 2. The finished laminated foam sheet remains flexible and does not delaminate.

This article can be washed and dried multiple times without the layers delaminating or getting an orange-peel appearance. The orange-peel appearance occurs when the cells of the foam open and close and the covering fabric puckers into or away from the foam. One cause of the orange-peel is the foam and fabric having different shrinkage rates after heating and cooling, washing, and other processing steps. Therefore, it is preferable to choose foam and fabric materials having similar shrinkage rates. Typically, the foam shrinkage rate is less than about 5%. Further, the method of producing the laminated foam sheet, as described herein, alleviates the orange-peel effect.

The fabric layers 1 and 3 are preferably polyester but can be stretchable nylon, cotton, or any other material which is chosen to have a shrinkage rate and stretch similar to the foam material. The foam is selected based on weight, density and cell structure. In one embodiment, the foam has a density of 33-36 gram/meter² and a hardness of 55-60° C. The hardness of the foam is selected so that the foam is pliable. The foam density is selected, in one embodiment, so that the foam has a small tight cell structure. Finally, the resin is selected so that it will bond the fabric to the foam to create a laminated foam sheet and also be moldable into a final product.

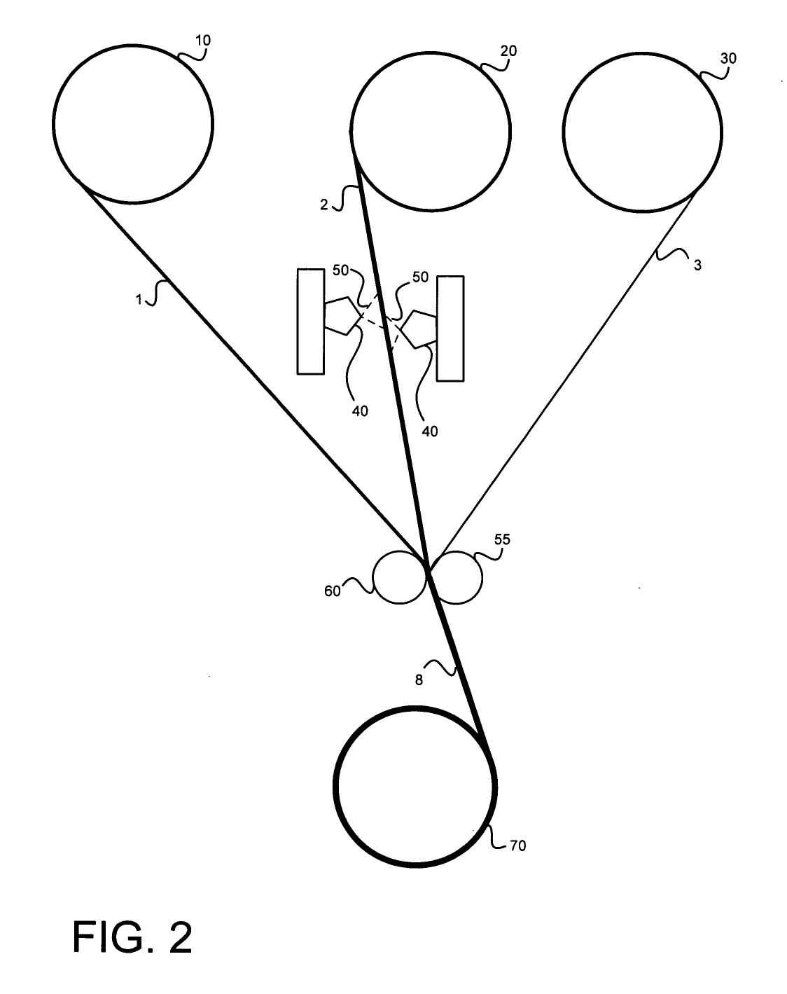

A first preferred method of manufacture is shown in FIG. 2. FIG. 2 shows a two-sided laminating process. Alternatively, a single-sided laminate process can be used as discussed below. As shown in FIG. 2, a first roller 10 holds fabric 1. A second roller 20 contains a roll of the foam 2 and a third roll 30 contains the second fabric 3. Typically, in a preferred embodiment, the foam is about 5 mm thick and 60 inches wide. Preferably, the three materials are simultaneously fed to a set of laminating rollers 55 and 60, which apply pressure to join the three materials together thereby creating the laminated foam sheet. In one embodiment, the rollers 55 and 60 are heated to speed the laminating process between the fabric layers 1 and 3 and the foam 2. As the foam 2 is fed to rollers 55 and 60, it passes spray units 40, which spray resin 50 onto the foam. Preferably, the resin covers the entire surface of the foam. The finished article, the laminated foam sheet, is wound onto roller 70.

In an alternative embodiment, the laminating is done in two separate steps. Initially, material 1 is laminated to the foam 2 with the laminate of 1 and 2 being wound onto roller 70. Roller 20 is then substituted with roller 70 and fabric 3 is laminated to the laminate of foam 2 and material 1 such that fabric 3 is on the opposite side of the foam from fabric 1. In this second step, resin 50 from sprayheads 40 is only applied to the open surface of foam 2.

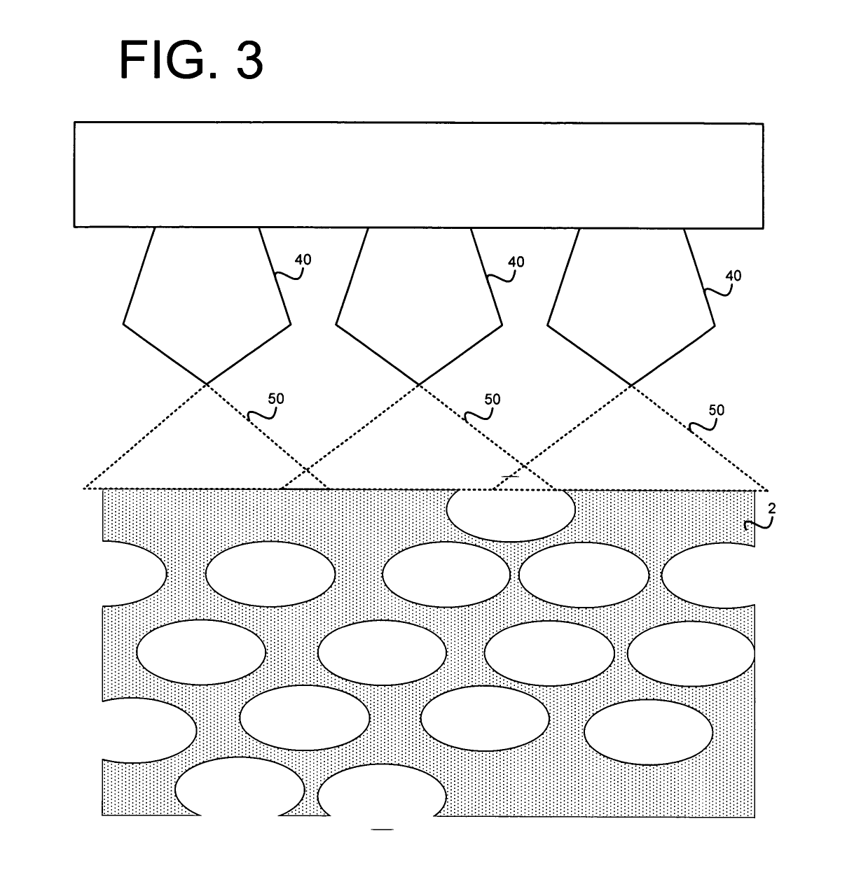

FIG. 3 shows a detailed view of the application of resin 50 to the foam material 2 according to one preferred embodiment of the invention. As shown, there are three spray heads 40 for spraying the resin 50 onto each site of the foam. Each of the spray heads 40 preferably has a spray pattern partially overlapping the spray pattern of the adjacent spray heads. It should be noted that it is not essential that the spray patterns overlap. However, the overlap of the spray allows for better coverage including a substantially flat and uniform resin coating, completely filling the exposed foam cells. Additionally, the resin permeates the surface of the foam 2. More spray heads 40 or fewer spray heads 40 can be used to achieve the desired coverage. However, preferably three spray heads are used to achieve sufficient coverage of resin on the foam.

While any number of spray heads or other application devices may be used, it is presently preferred to use two, or preferably three, spray heads to spray resin onto the foam. The amount of resin sprayed is a function of at least the resin, the nozzles, and the air pressure. A sufficient quantity of resin is sprayed onto the foam so that the exposed cells of the foam are completely filled and some resin permeates into the foam. Preferably, the resin does not permeate the entire thickness of the foam. The spraying of the resin on the foam creates planar surfaces of resin onto which the fabrics 1 and 3 are ultimately laminated. In an alternate embodiment, the spray heads 40 are replaced with rollers such that the resin is applied to the foam using rollers. Rollers can be used as long as a sufficient quantity of resin is placed onto the foam such that it creates a substantially flat, uniform surface of resin and the resin fills the cells completely preferably without permeating the entirety of the foam.

Covering the entire surface of the foam to which the outer fabric layers are applied and filling the surface cells with resin assists in preventing orange-peel by preventing the foam from shrinking. Additionally, it prevents the fabric from being able to pucker into or away from the foam cells. Coating the entire surface of the foam prevents the foam and the entire structure from yellowing due to age. Additionally, the resin coating prevents the fabric from yellowing during subsequent molding processes. During molding, heat is applied to the article which causes the foam to outgas. This outgassing tends to yellow the laminated fabric. The resin substantially prevents the outgassing through the fabric, thereby preventing yellowing.

After the laminated foam sheet is produced, i.e., both surfaces of the foam have fabric laminated to them, the laminated foam sheet is ready for cutting and molding to create items such as molded foam bra inserts. The molded article can be molded in any number of different ways. Preferably, during molding, the temperature of the mold is accurately controlled by heating the mold and not a stage upon which the mold is placed.

Ultimately, the molded article is flexible, stretchable, and will retain its shape after molding. During the molding process, the foam will outgas, however, due to the coating of resin, the outer layer of fabric will not yellow. Additionally, the resin prevents delamination and orange-peeling. Finally, the resin acts as a shrinkage deterrent so that the product lasts longer because its surface does not change over time due to orange-peeling, yellowing, delamination, or the like.

Although the present invention was discussed in terms of certain preferred embodiments, the description is not limited to such embodiments. Rather, the invention includes other embodiments including those apparent to a person of ordinary skill in the art.

1. A method of manufacturing a laminated foam sheet comprising:
applying resin on a first surface of a foam material such that the resin fills exposed cells of the foam material and provides a planar surface of resin across the first surface of the foam material;
placing a first flexible material in contact with the resin; and
applying pressure to the foam material, resin, and flexible material combination.

2. The method of manufacturing a laminated foam sheet according to claim 1, wherein the resin applied on the first surface does not permeate an entire thickness of the foam.

3. The method of manufacturing a laminated foam sheet according to claim 1, wherein the resin applied by spraying.

4. The method of manufacturing a laminated foam sheet according to claim 1, wherein the resin applied by rolling.

5. The method of manufacturing a laminated foam sheet according to claim 1, further comprising:
applying resin on a second surface of the foam material opposite the first surface;
placing a second flexible material in contact with the resin; and
applying pressure to the laminated foam sheet, resin, and second flexible material.

6. The method of manufacturing a laminated foam sheet according to claim 5, wherein the resin applied on the second surface does not permeate an entire thickness of the foam material.

7. An article of manufacture comprising:
a first foam layer, the foam layer having a thickness and first and second opposed surfaces;
a first flexible material layer laminated to the first foam surface; and
a layer of resin between the first flexible material layer and the first foam surface, said resin providing a planar surface for the first flexible material layer to be bonded to, the resin filling the exposed cells of the first surface of the foam layer.

8. The article of manufacture according to claim 7, wherein the resin on the first surface does not permeate the entire thickness of the foam layer.

9. An article of manufacture according to claim 7, further comprising:
a second flexible material layer; and
a layer of resin between the second flexible material layer and the second foam surface, the resin providing a planar surface for the second flexible material layer to be bonded to, the resin filling the exposed cells of the second surface of the foam layer.

10. The article of manufacture according to claim 9, wherein the resin on the second surface does not permeate the entire thickness of the foam layer.

11. The article of manufacture according to claim 10, wherein the foam has a density of about 35 g/m².

12. The article of manufacture according to claim 11, wherein the foam is about 5 mm thick.

13. The article of manufacture according to claim 7, wherein the first flexible material layer is fabric.

14. A method of manufacturing a laminated foam sheet comprising:
applying resin on a first and a second opposed surfaces of a foam material such that the resin fills exposed cells of the foam material and provides a planar surface of resin across the first and second surfaces of the foam material;
placing a first flexible material in contact with the resin on the first foam surface;
placing a second flexible material in contact with the resin on the second foam surface; and
applying pressure to the foam material, resin, and first and second flexible material combination.

15. The method of manufacturing a laminated foam sheet according to claim 14, wherein the resin applied on the first and second surfaces does not permeate an entire thickness of the foam material.

16. The method of manufacturing a laminated foam sheet according to claim 14, wherein the resin applied by spraying.

17. The method of manufacturing a laminated foam sheet according to claim 14, wherein the resin applied by rolling.
